(19) United States
(12) Patent Application Publication
(10) Pub. No.: US 2012/0309573 A1
(43) Pub. Date: Dec. 6, 2012

(54) PAH-Free Drive Belt, in Particular Toothed Belt

(76) Inventors: Michael Well, Vechelde (DE); Reinhard Teves, Seelze (DE); Thomas Baltes, Hannover (DE); Sener Guevenc, Hannover (DE); Heiko Sattler, Hannover (DE)

(21) Appl. No.: 13/557,956

(22) Filed: Jul. 25, 2012

Related U.S. Application Data
(63) Continuation of application No. PCT/EP2011/051429, filed on Feb. 2, 2011.

(30) Foreign Application Priority Data
Apr. 12, 2010 (DE) 10 2010 016 393.7

(51) Int. Cl. F16G 1/28

(52) U.S. Cl. 474/205

(57) ABSTRACT

A drive belt with a main body made of a polymeric material having resilient properties, comprising a top layer as the belt rear face and a base having a force transfer zone, wherein moreover at least one tension cord is embedded in the main body. Three drive belt variants are specified. In addition, the top layer and/or the force transfer zone are/is provided with a pressure-resistant coating. The drive belt is characterized in that at least the top layer and/or the base are/is free from carbon black and free from polycyclic aromatic hydrocarbons (PAH). The tension cord and/or abrasion-resistant coating are/is preferably prepared with an adhesive system that is likewise free from carbon black and PAH.

### CROSS REFERENCE TO RELATED APPLICATIONS

This application is a continuation application of international patent application PCT/EP 2011/051429, filed Feb. 2, 2011, designating the United States and claiming priority from German application 10 2010 016 393.7, filed Apr. 12, 2010, and the entire content of both applications is incorporated herein by reference.

### FIELD OF THE INVENTION

The invention relates to a drive belt with a base made of a polymeric material with elastic properties, comprising an outer layer as belt backing and a substructure with a force-transmission zone, where
in a first variant, there is at least one tension member embedded in the base; or,
in a second variant, there is an intermediate layer made of a polymeric material with elastic properties arranged between the outer layer and the substructure, and there is at least one tension member embedded in the intermediate layer here; or,
in a third variant, at least one tension member forms a reinforcement layer, and there is an intermediate layer made of a polymeric material with elastic properties arranged here between the reinforcement layer and the outer layer and/or between the reinforcement layer and the substructure;
   and moreover the outer layer and/or the force-transmission zone here has/have an abrasion-resistant coating.

### BACKGROUND OF THE INVENTION

Drive belts, which are also called force-transmission belts and which in the operating condition are mostly continuous belts, can take the form of flat belts, V-belts, V-ribbed belts, toothed belts, and clutch belts. V-ribbed belts and toothed belts are particularly important, and in this connection reference is made to the following patent literature:

| V-ribbed belts | Toothed belts |
|---|---|
| DE 38 23 157 A1 | EP 0 599 145 B1 |
| DE 100 16 351 A1 | EP 0 737 228 B1 |
| DE 10 2006 007 509 A1 | EP 0 866 834 B1 |
| EP 0 590 423 A2 | EP 1 088 177 B1 |
| EP 0 737 228 B1 | EP 1 129 308 B1 |
| EP 0 831 247 B1 | EP 1 795 645 A1 |
| EP 0 866 834 B1 | WO 2005/080821 A1 |
| EP 1 108 750 A1 | WO 2006/066669 A1 |
| EP 1 129 308 B1 | U.S. Pat. No. 5,417,618 |
| WO 2009/066492 A1 | JP 2008-291395 A |
| U.S. Pat. No. 3,981,206 | |
| U.S. Pat. No. 5,026,327 | |

US 2003/0121729 A1

In order to achieve the elasticity of a drive belt, the base, and therefore the outer layer and the substructure, are composed of a polymeric material with elastic properties, and particular mention may be made here of the following two groups of materials: elastomers and thermoplastic elastomers. Elastomers based on a vulcanized rubber mixture are particularly important.

In one of the three variants mentioned in the introduction, the drive belt has at least one embedded tension member running in the longitudinal direction of the belt, and in particular here a plurality of tension members form a reinforcement layer or tensile layer. A tension member constructed as a cord is particularly important here, and the prior art gives various ideas for relevant materials. The significant types of materials are: steel, polyamide (PA), aramid, polyester, glass fibers, carbon fibers, basalt, polyether ether ketone (PEEK), polyethylene tereph-thalate (PET), and polyethylene 2,6-naphthalate (PEN). The tension member moreover has mostly been prepared with an adhesive system, for example with a resorcinol-formaldehyde latex (RFL), thus ensuring long-term effectiveness of adhesion to the surrounding polymeric material in one of the three variants mentioned in the introduction.

In particular the force-transmission zone of a drive belt has an abrasion-resistant coating, which additionally serves for noise-reduction and moreover also can have been rendered oil-resistant. The following are used here: a flock covering, in particular in the form of a cotton flock or of an aramid flock, a thin fiber-filled (for example, aramid-fiber-filled) elastic polymer layer, a textile covering, in particular in the form of a woven fabric, a warp-knitted fabric or a weft-knitted fabric, or a foil (for example, PTFE foil), or a foil composite (for example, PA PTFE foil). In respect of the relevant prior art, particular reference is made to the following patent literature:

| | |
|---|---|
| DE 38 23 157 A1 | DE 10 2008 012 044 A1 |
| DE 100 16 351 A1 | U.S. Pat. No. 3,981,206 |
| DE 10 2006 007 509 A1 | U.S. Pat. No. 6,491,598 |
| DE 10 2007 062 285 A1 | |

The coating is mostly prepared on the side that has contact with the base of the drive belt, in particular with the substructure thereof, in a manner that promotes adhesion, for example by using RFL.

Developments in the field of drive belts have hitherto focused on the provision of low-noise coatings that are also abrasion-resistant, and also on the search for high-performance tension members and polymer materials.

For many products, such as household equipment, electric-powered tools, and garden equipment, there is now an increasing demand for use of materials having low pollutant content, in particular no pollutant content. In the case of polymer mixtures with applications in vehicle construction, this development work has hitherto focused on ensuring that polymer materials have low N-nitrosamine content, in particular no N-nitrosamine content.

### SUMMARY OF THE INVENTION

With a view to further development, the object of the invention now consists in providing drive belts which have low pollutant content, in particular no pollutant content, and which moreover can be used without reservations in applications involving body contact.

The object is achieved in that at least the outer layer and/or the substructure is/are free from carbon black and free from polycyclic aromatic hydrocarbons (PAHs).

In the second or third variant, it is advantageous that the outer layer and the substructure, and also the intermediate layer, are free from carbon black and PAH-free. The polymer mixtures comprise by way of example silica in place of the carbon black filler which intrinsically mostly comprises PAH. The mineral-oil-based plasticizer, which likewise mostly comprises PAH, is replaced by an appropriate PAH-free plasticizer.

Since the side on which the tension member and the abrasion-resistant coating are in contact with the base has mostly been prepared with an adhesive system, it is preferable to use an adhesive system which is likewise free from carbon black and PAH-free.

The drive belt is preferably free from further pollutants, in particular free from chlorine or from any chlorine-containing substance. In particular, chloroprene rubber (CR) is avoided here.

In respect of the adhesive system for the abrasion-resistant coating, use of the following variants is preferred:
The adhesive system is an RFL based on vinylpyridine.
The adhesive system is an adhesive foil which in particular is composed of a polyolefin or of a polyamide (PA). The polyolefin here is preferably polyethylene (PE) or polypropylene (PP).
The adhesive system is based on a silane treatment, in particular when a textile covering is used.

The adhesive system for the abrasion-resistant coating can also have a dye. An advantage of the RFL-free adhesive system is that it is colorless, and it is therefore possible by way of example to color the woven as desired. It is also possible to incorporate a dye by mixing into the polymer mixture of the outer layer and/or of the substructure, since carbon black filler is avoided here.

A toothed belt of the prior art (Table 1) is compared with a PAH-free toothed belt of the invention (Table 2) on the basis of a mixing formulation, specifically supplemented by a comparison of different adhesive systems. Both toothed belts had a tension member arrangement of the first variant.

TABLE 1

| Mixture constituents | Quantitative proportions | |
|---|---|---|
| Chlorprene (CR) | 100 | phr |
| N 550 carbon black | 50 | phr |
| Mineral oil | 8 | phr |
| Magnesium oxide | 4 | phr |
| Zinc oxide | 3 | phr |
| ODPA antioxidant (a) | 2 | phr |
| Vulkanox 3100 (b) | 2 | phr |
| Stearic acid | 1 | phr |
| Vulkacit DM/C (c) | 1 | phr |

(a) antioxidant: octylated diphenylamine, Luvomaxx ODPA from Lehmann & Voss
(b) antioxidant: mixture made of diaryl-p-phenylenediamine (DTPD) from Lanxess
(c) accelerator: dibenzothiazole disulfide (MBTS) from Lanxess
Tension member: Glass cord with CR-containing RFL
Coating for the force-transmission zone: Polyamide (PA) woven with CR-containing RFL

TABLE 2

| Mixture constituents | Quantitative proportions | |
|---|---|---|
| Ethylene-propylene-diene rubber (EPDM) | 100 | phr |
| Silica | 40 | phr |
| Glycol | 2 | phr |
| Sorbic acid | 10 | phr |
| Zinc oxide | 8 | phr |
| Paraffin oil | 10 | phr |
| Vulkanox ZMB2 (d) | 2 | phr |
| Ultramarine blue | 3 | phr |
| Perkadox 14-40 (e) | 6 | phr |

(d) Antioxidant: zinc methylmercaptobenzimidazole
(e) Peroxide crosslinking agent: di(tert-butylperoxyisopropyl)benzene from Akzo
Tension member: Glass cord with vinylpyridine RFL
Coating for the force-transmission zone: Polyamide (PA) woven with vinylpyridine RFL and dye

Other advantageous possibilities for design of the drive belt of the invention are presented in still more detail in conjunction with the description of the figures.

### BRIEF DESCRIPTION OF THE DRAWINGS

The invention will now be described with reference to the drawings wherein:

FIG. 1 shows a structure of a toothed belt; and,

FIG. 2 shows details of a tension member.

### DESCRIPTION OF THE PREFERRED EMBODIMENTS OF THE INVENTION

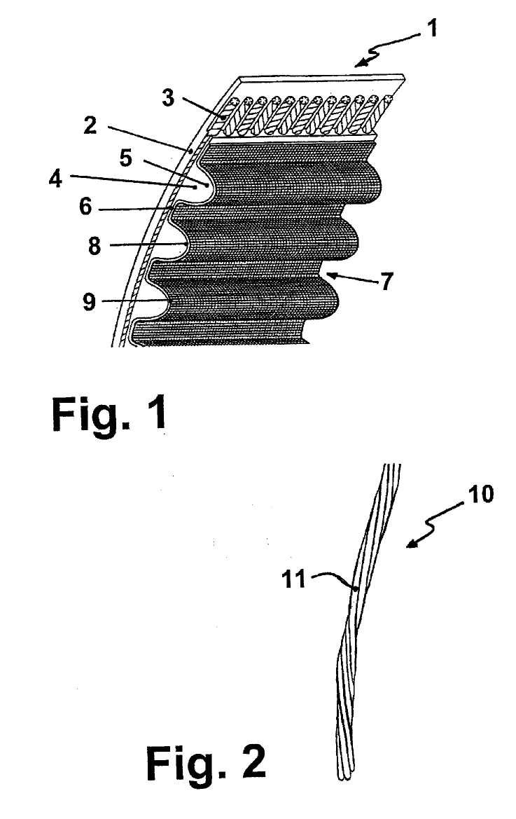

FIG. 1 shows a drive belt 1 in the form of a toothed belt with an outer layer 2 as belt backing, with a plurality of tension members 3 running parallel and embedded in the longitudinal direction of the belt, and also with a substructure 4. The substructure has a toothed profile, comprising teeth 5 and bridges 6 between the teeth, and comprises the force-transmission zone 7.

The outer layer 2 and the substructure 4 here, as overall unit, form the base made of a polymeric material with elastic properties, in particular taking the form of a vulcanized rubber mixture, comprising at least one rubber component and mixture ingredients. Rubber component used in particular comprises ethylene-propylene rubber (EPM), ethylene-propylene-diene rubber (EPDM), (partially) hydrogenated nitrile rubber (HNBR), fluororubber (FKM), natural rubber (NR), styrene-butadiene rubber (SBR) or butadiene rubber (BR), which are used in unblended form or a form blended with at least one further rubber component, in particular with one of the abovementioned types of rubber, for example taking the form of a EPM/EPDM blend or SBR/BR blend. HNBR, EPM, EPDM or an EPM/EPDM blend is particularly important here. The mixture ingredients comprise at least one crosslinking agent or one crosslinking agent system (crosslinking agent and accelerator). Further mixture ingredients are mostly also a filler and/or a processing aid and/or a plasticizer and/or an antioxidant, and also optionally further additives, such as fibers for increasing the strength, and color pigments. In this connection, reference is made to the general state of rubber mixture technology.

The rubber mixture is free from carbon black and PAH-free, and specifically with simultaneous avoidance of CR as rubber component.

The tension members 3 here have been embedded in the base without any intermediate layer. Each cord-structure tension member is composed of a filament material, for example of glass filaments. For a toothed belt in an oil environment, lang-lay cords are better here than normal reverse-lay cords. Further measures relating to the tension member are explained in still more detail in conjunction with FIG. 2.

In particular the substructure 4 of the drive belt 1 can moreover comprise fibers uniformly distributed, in particular textile fibers. The fibers are composed of cotton, cellulose, aramid, in particular p-aramid, polyamide, in particular PA6 or PA.6.6, polyvinyl acetal (PVA) or polyethylene terephthalate (PET). The fibers can take the form of a pulp (fiber slurry) or short fibers. In the case of short fibers, the length is ≦8 mm, in particular ≦6 mm.

The force-transmission zone 7 of the drive belt 1 is particularly susceptible to wear due to abrasion, heat, and the effect of oils. For this reason, the force-transmission zone has a coating in the form of a textile covering 8, for example taking the form of a woven or knit. The textile covering can by way of example additionally have been saturated, as in the teaching of document WO 2005/080821 A1, with a fluorine-containing plastic which in particular is polytetrafluoroethylene (PTFE), and specifically with a high fill level of the plastic, where a polymer coating (seal) is simultaneously formed at additional oil-resistant protective layer 9. The two sublayers 8 and 9 with different functions appear here as combined protective layer.

The outer layer 2 of the drive belt 1 can also have a coating, for example in the manner described above.

The drive belt 1 in its particular embodiment as toothed belt is particularly suitable for driving an oil pump of an engine, for example of a motor-vehicle engine.

FIG. 2 shows a strand 10, formed from a group of filaments 11, where a strand is formed by from 100 to 1000 filaments, in particular from 500 to 700 filaments. The strand here mostly takes the form of a helical strand, and this is illustrated in FIG. 2. A group of strands finally forms the cord. A cord is mostly composed of at least five strands, in particular of from 10 to 20 strands. The cord finally forms the tension member.

The filaments 11 are composed by way of example of glass. This means that the strands 10 and finally the cord in the form of effective tension member 3 (FIG. 1) are therefore also composed of the inorganic material.

The filaments 11, the strands 10 or the cord can have been prepared. The cord is often prepared in a manner that promotes adhesion, for example by using RFL. It is particularly advantageous to pre-prepare the filaments 11, thus forming prepared strands 10, and finally also a prepared cord. The preparation of the filaments is achieved here in particular with a vinylpyridine RFL to form a filament sheath.

It is understood that the foregoing description is that of the preferred embodiments of the invention and that various changes and modifications may be made thereto without departing from the spirit and scope of the invention as defined in the appended claims.

### KEY

### Part of the Description

1 Drive belt (toothed belt)
2 Outer layer in the form of belt backing
3 Tension member
4 Substructure
5 Tooth
6 Bridge between teeth
7 Force-transmission zone
8 Coating in the form of a textile covering (tooth covering)
9 Protective layer
10 Strand
11 Filament

What is claimed is:

1. A drive belt with a base made of a polymeric material with elastic properties, comprising an outer layer as belt backing and a substructure with a force-transmission zone, where
in a first variant, there is at least one tension member embedded in the base, or
in a second variant, there is an intermediate layer made of a polymeric material with elastic properties arranged between the outer layer and the substructure, and there is at least one tension member embedded in the intermediate layer here; or
in a third variant, at least one tension member forms a reinforcement layer, and there is an intermediate layer made of a polymeric material with elastic properties arranged here between the reinforcement layer and the outer layer and/or between the reinforcement layer and the substructure;
and moreover the outer layer and/or the force-transmission zone here has/have an abrasion-resistant coating, wherein at least the outer layer and/or the substructure is/are free from carbon black and free from polycyclic aromatic hydrocarbons (PAHs).

2. The drive belt as claimed in claim 1, wherein at least the outer layer and/or the substructure is/are free from additional pollutants.

3. The drive belt as claimed in claim 1, wherein the intermediate layer in the second or third variant is free from carbon black and free from polycyclic aromatic hydrocarbons (PAHs).

4. The drive belt as claimed in claim 1, wherein the intermediate layer in the second or third variant is free from additional pollutants.

5. The drive belt as claimed in claim 1, wherein a side on which the tension member and/or the abrasion-resistant coating is/are in contact with the base has been prepared with an adhesive system.

6. The drive belt as claimed in claim 5, wherein the adhesive system is free from carbon black and free from polycyclic aromatic hydrocarbons (PAHs).

7. The drive belt as claimed in claim 5, wherein the adhesive system is free from additional pollutants.

8. The drive belt as claimed in claim 2, wherein the additional pollutants are at least free from chlorine or from any chlorine-containing substance.

9. The drive belt as claimed in claim 5, wherein the adhesive system for the tension member and/or the abrasion-resistant coating is a resorcinol-formaldehyde latex (RFL) based on vinylpyridine.

10. The drive belt as claimed in claim 5, wherein the adhesive system for the abrasion-resistant coating is an adhesive foil.

11. The drive belt as claimed in claim 10, wherein the adhesive foil is composed of a polyolefin or of a polyamide (PA).

12. The drive belt as claimed in claim 11, wherein the adhesive foil is composed of polyethylene (PE) or polypropylene (PP).

13. The drive belt as claimed in claim 5, wherein the adhesive system for the abrasion-resistant coating is based on a silane treatment.

14. The drive belt as claimed in claim 8, wherein the adhesive system for the abrasion-resistant coating has a dye.

15. The drive belt as claimed in claim 1, wherein the polymeric material of the outer layer and/or of the substructure and/or of the intermediate layer for the tension member is a vulcanized rubber mixture, comprising at least one rubber component and also mixture ingredients.

16. The drive belt as claimed in claim 15, wherein the rubber component is selected from the group consisting of ethylene-propylene rubber (EPM), ethylene-propylene-diene rubber (EPDM), (partially) hydrogenated nitrile rubber (HNBR), fluororubber (FKM), natural rubber (NR), styrene-butadiene rubber (SBR), and butadiene rubber (BR), which are used in unblended form or in a blend with at least one further rubber component.

17. The drive belt as claimed in claim 1, wherein the outer layer and/or the substructure comprise(s) a dye.

18. The drive belt as claimed in claim 1, wherein the drive belt is designed as a toothed belt.

19. The drive belt as claimed in claim 16, wherein the at least one further rubber component is selected from the group consisting of EPM, EPDM, HNBR, FKM, NR, SBR, and BR.
